(19) United States
(12) Patent Application Publication
(10) Pub. No.: US 2009/0040985 A1
(43) Pub. Date: Feb. 12, 2009

(54) METHOD AND APPARATUS FOR SUPPORTING AD-HOC NETWORKING OVER UMTS PROTOCOL

(75) Inventors: Ahmed Barnawi, Manchester (GB); John Graham Gardiner, West Yorkshire (GB)

Correspondence Address: ADAMS INTELLECTUAL PROPERTY LAW, P.A., Suite 2350 Charlotte Plaza, 201 South College Street, CHARLOTTE, NC, 28244, US

(73) Assignee: UNIVERSITY OF BRADFORD, Bradford (GB)

(21) Appl. No.: 12/064,648

(22) PCT Filed: Aug. 22, 2006
(86) PCT No.: PCT/GB2006/003132

§ 371 Date: Jul. 30, 2008

(30) Foreign Application Priority Data
Aug. 26, 2005 (GB) 01517488.3

(51) Int. Cl. H04J 3/06

(52) U.S. Cl. 370/336

(57) ABSTRACT

A method and apparatus are provided for ad hoc networking over a universal mobile telecommunications system (UMTS). In the method, if user equipment (40A) (such as a mobile phone) is not within normal cell coverage (20), then in an uplink procedure a message which would normally have not be able to be transmitted directly from the User Equipment (40A) to a Base Station (10) is instead forwarded towards the Base Station (10) via one or more intermediate User Equipments (40B). In the method, the user equipment (40A) is arranged to synchronise itself with the Base Station (10) to acquire timeslot and frame synchronisations and thence perform probing activities to build up a list of neighbouring User Equipments. From this list and power and signal to interference calculations the user equipment (40A) is able to work out the relative positions of its neighbours with respect to the Base Station and itself and come to a routing decision for forwarding its message towards the Base Station.

The invention relates to method and apparatus for supporting ad hoc networking over a UMTS protocol.

UMTS (commonly referred to as 3G) offers significant capacity and broadband capabilities for supporting large numbers of voice and data customers. However, one of the most important engineering objectives for cellular operators remains the problem of maximising the utilisation of relatively scarce radio resources with the least complex and the most cost effective technology available.

System optimisation has generally been tackled by addressing the fixed hardware of the system. For instance, cell sectorisation and cell splitting are examples of techniques used to improve the capacity and coverage of the system. Cell sectorisation is implemented by dividing a cell into a number of sectors using directional antennae. For a given cluster size, cell sectorisation reduces co-channel interference as a result of the front-to-back ratio in the antennae gain and hence the signal-to-interference ratio is improved. However, cell sectorisation reduces the spectrum efficiency (traffic per unit frequency per unit area) as channel resources are distributed more thinly among the various sectors. Splitting the cell into multiples of small cells does not affect the number of channels per cell, however it increases the overall capacity linearly proportional to the number of the new small cells, the drawback is the increased costs of the wired backbone and base station sites.

In cellular communications, transmission on the uplink direction (from user handset to base station) limits the coverage of the cell. This is basically due to the limitation on transmission power of the user's handset. To increase the cell coverage, the network operator generally has to improve the reception of the users signal at the base station. However, as background interference is a very significant problem in the CDMA (code division multiple access) system utilised in UMTS systems, increasing power from a users handset in order to improve reception of the signal at the base station is not a viable solution. In fact, a strict control of the user's transmitting power is required in order to try and minimise background interference. The complexity of power control in order to achieve coverage improvement increases with the increase in the number of simultaneous transmissions by accessing users.

Ad hoc networking has been suggested in the field of wireless networking to set up an infra-structureless wireless communication between users in a particular locality. However, the implementation of such ad-hoc networks within the UMTS environment proves problematical as any system will need to work alongside the existing infrastructure in a seamless manner.

According to a first aspect of the invention, there is provided a method for ad hoc networking over a universal mobile telecommunications system (UMTS), wherein, in an uplink procedure at a User Equipment end in which a message is to be transmitted from the User Equipment to a Base Station, the User Equipment is arranged to not transmit its message directly to the Base Station, but instead to forward it towards the Base Station via one or more intermediate User Equipments by means of (1) synchronising itself with the Base Station to acquire timeslot and frame synchronisations that will enable the User Equipment to listen to a broadcast channel and measure the reference transmit power of that channel; (2) performing probing activities to build up a list of neighbouring User Equipments and work out the relative positions of its neighbours with respect to the Base Station and itself (3) on the basis of the relative positioning information come to a routing decision for forwarding its message towards the Base Station; (4) performing a resource allocation function in which transmission resources are allocated to support transmission of the message; and (5) forwarding the message.

Particular preferred features of the first aspect are set out in dependent claims 2 to 48 as appended hereto.

The invention of the first aspect may be combined with any/all inventions as set out in the other aspects in any logical combination and may be combined with any features as set out in this application as a whole.

A second aspect of the invention provides a method of synchronising User Equipments within an Ad hoc networking environment, wherein synchronisation between User Equipments and a Base Station is acquired in two ways: (i) Listening to a beacon channel transmitted by the Base Station which carries synchronisation information; and (ii) If the beacon channel cannot be heard by a particular User Equipment, then synchronising the particular User Equipment by means of peer-to-peer synchronisation.

The invention of the second aspect may be combined with any/all inventions as set out in the other aspects in any logical combination and may be combined with any features as set out in this application as a whole. However, some preferred features of the synchronisation method are set out in claims 2 to 8 as appended hereto.

According to a third aspect of the invention, there is provided a method of mapping the surrounding environment of a User Equipment within a telecommunications network for facilitating ad hoc communications between User Equipments, wherein the method comprises the user equipment transmitting a signal to neighbouring user equipments and building a Neighbour List listing and classifying said neighbouring user equipments according to their positions relative to the User Equipment and the Base Station.

The invention of the third aspect may be combined with any/all inventions as set out in the other aspects in any logical combination and may be combined with any features as set out in this application as a whole. However, some preferred features of the mapping/probing method are set out in claims 9 to 21 as appended hereto.

According to a fourth aspect of the invention, there is provided a method of resource allocation for allocating resources to User Equipments operating within an ad hoc telecommunications environment, wherein resources are allocated in a decentralised fashion where a node to which the message is to be forwarded, known as the Parent node, is given the superiority to allocate resources for transmitting nodes, referred to hereafter as Child nodes.

The invention of the fourth aspect may be combined with any/all inventions as set out in the other aspects in any logical combination and may be combined with any features as set out in this application as a whole. However, some preferred features of the resource allocation method are set out in claims 22 to 26 as appended hereto.

According to a fifth aspect of the invention, there is provided a method for detecting and reacting to topology changes within an ad-hoc networking system in which a Topology Detection Function is periodically performed for detecting positional changes with regard to User Equipment and Neighbouring User Equipments with respect to a Base Station transmitter.

The invention of the fifth aspect may be combined with any/all inventions as set out in the other aspects in any logical combination and may be combined with any features as set out in this application as a whole. However, some preferred features of the topology detecting and reacting method are set out in claims 28 to 37 as appended hereto.

According to a sixth aspect of the invention, there is provided a method for power control of User Equipments within an ad-hoc network, wherein the transmission power of each transmitter User Equipment is controlled by a Signal to Interference Ratio based Power Control function so that it does not fall below a level that affects the target quality of the link, nor increases more than necessary.

The invention of the sixth aspect may be combined with any/all inventions as set out in the other aspects in any logical combination and may be combined with any features as set out in this application as a whole. However, some preferred features of the power control method are set out in claims 39 to 48 as appended hereto.

According to a seventh aspect of the invention, there is provided User Equipment adapted to operate within an Ad hoc networking environment, wherein the User Equipment comprises a transmitter for transmitting signals to a base station, a receiver for receiving signals from a base station, memory for storing incoming messages, control software and other data, and a processing unit for controlling functions of the User Equipment, the User Equipment being characterised in that the receiver is further arranged, in an Ad hoc operating mode, to (1) synchronise itself with the Base Station to acquire timeslot and frame synchronisations that will enable the User Equipment to listen to a broadcast channel and measure the reference transmit power of that channel; (2) perform probing activities to build up a list of neighbouring User Equipments and work out the relative positions of its neighbours with respect to the Base Station and itself (3) on the basis of the relative positioning information come to a routing decision for forwarding its message towards the Base Station; (4) perform a resource allocation function in which transmission resources are allocated to support transmission of the message; and (5) forward the message.

Preferably, if the User Equipment is determined to be in a location in which signals from the transmitter will be able to reliably reach the base station directly then messages are sent directly to the base station, however, where signals will not be able to reliably reach the base station, then the User Equipment is arranged to operate in an Ad hoc mode in which messages to be sent from the User Equipment to the base station are routed to the base station via one or more of the neighbouring user equipments which form nodes, wherein the decision as to how to route the message from the User Equipment to a first such intermediate node between the user equipment and the base station is made in the course of the probing activities by building a list of nodes which neighbour the User Equipment, classifying the nodes according to their positions relative to the User Equipment and the base station and routing the message to that node amongst the neighbouring nodes which is determined to be both closer to the base station than the User Equipment and, amongst those which are closer to the base station, to be closest to the User Equipment itself

The invention of the seventh aspect may be combined with any/all inventions as set out in the other aspects in any logical combination and may be combined with any features as set out in this application as a whole. However, some preferred features of the User Equipment are set out in claims 51 onwards as appended hereto.

According to an eight aspect of the invention, synchronisation means are provided for User Equipment adapted to operate within an Ad hoc networking environment, wherein the User Equipment comprises a transmitter for transmitting signals to a base station, a receiver for receiving signals from a base station, memory for storing incoming messages, control software and other data, and a processing unit for controlling functions of the User Equipment, the synchronisation means enabling the User Equipment to synchronise itself with the Base Station in two ways by: (i) Listening to a beacon channel transmitted by the Base Station which carries synchronisation information; and (ii) if the beacon channel cannot be heard, then synchronising the particular User Equipment by means of peer-to-peer synchronisation to acquire the timeslot and frame synchronisations that will enable it to listen to a broadcast channel and measure the reference transmit power of that channel, wherein the synchronisation means comprises a packet receiver and a correlator arranged such that a message packet including predetermined content which is guaranteed to be present at a particular place may be received at the packet receiver from a neighbouring user equipment that is already synchronised with the base station and a correlation function performed within the correlator to determine when the predetermined content is transmitted by the synchronised User Equipment.

The invention of the eighth aspect may be combined with any/all inventions as set out in the other aspects in any logical combination and may be combined with any features as set out in this application as a whole. However, some preferred features of the synchronisation means are set out in claims 56 to 61 as appended hereto.

According to a ninth aspect of the invention, probing means are provided for User Equipment adapted to operate within an Ad hoc networking environment, the probing means being arranged to map the surrounding environment of a User Equipment within a telecommunications network for facilitating ad hoc communications between User Equipments, wherein the probing means is arranged, on the basis of the user equipment transmitting probing message signals to neighbouring user equipments and receiving responses therefrom, to build a Neighbour List listing and classifying said neighbouring user equipments according to their positions relative to the User Equipment and the Base Station, wherein the User Equipment comprises a transmitter for transmitting signals to a base station, a receiver for receiving signals from a base station, memory for storing incoming messages, control software and other data, and a processing unit for controlling functions of the User Equipment, and said probing means comprises: a Probing Messages Composer for composing probing messages for requesting information from neighbouring User Equipments and for negotiating deals relating to the forwarding of messages towards the base station; a Probing Messages Transmitter for transmitting probing messages to neighbouring user equipments; a Probing Activities Controller for controlling probing activities; a Probing Messages Receiver for receiving probing messages from neighbouring user equipments and for receiving responses to probing messages that have been previously sent by the user equipment to neighbouring user equipments; a Probing Message Selector for classifying incoming probing messages and responses; a Probing Test Unit; and a Probing Decision Unit.

The invention of the ninth aspect may be combined with any/all inventions as set out in the other aspects in any logical combination and may be combined with any features as set out in this application as a whole.

According to a tenth aspect of the invention, resource allocating means are provided for User Equipment adapted to operate within an Ad hoc networking environment, the resource allocating means being arranged for allocating resources to User Equipments operating within an ad hoc telecommunications messaging environment, wherein resources are allocated in a decentralised fashion where a node to which a message is to be forwarded, known as the Parent node, is given the superiority to allocate resources for transmitting nodes, referred to hereafter as Child nodes.

The invention of the tenth aspect may be combined with any/all inventions as set out in the other aspects in any logical combination and may be combined with any features as set out in this application as a whole.

According to an eleventh aspect of the invention, there is provided a topology detection means for detecting and reacting to topology changes within an ad-hoc networking system in which a Topology Detection Function is periodically performed for detecting positional changes with regard to User Equipment and Neighbouring User Equipments with respect to a Base Station transmitter.

The invention of the eleventh aspect may be combined with any/all inventions as set out in the other aspects in any logical combination and may be combined with any features as set out in this application as a whole.

According to a twelfth aspect of the invention, there is provided a power control means for controlling the transmission power of User Equipments within an ad-hoc network, wherein the transmission power of each transmitter User Equipment is controlled by a Signal to Interference Ratio based Power Control function so that it does not fall below a level that affects the target quality of the link, nor increases more than necessary.

The invention of the twelfth aspect may be combined with any/all inventions as set out in the other aspects in any logical combination and may be combined with any features as set out in this application as a whole.

According to a thirteenth aspect of the invention, there is provided a frame structure for inband communications in an Ad hoc networking environment, where a message from a User Equipment is to be forwarded towards a Base Station via one or more intermediate User Equipments, wherein the frame structure comprises a plurality of sub-frames and includes portions for: conveying synchronisation information to enable synchronisation of User Equipment with the Base Station; conveying probing activity information for enabling the exchange of positional information between User Equipments within the Ad Hoc network; and conveying resource allocation information in which transmission resources are allocated to specific User Equipments at specific timeslots to support forwarding of the message.

The invention of the thirteenth aspect may be combined with any/all inventions as set out in the other aspects in any logical combination and may be combined with any features as set out in this application as a whole. However, some preferred features of the frame structure are set out in claims 105 to 115 as appended hereto.

For a better understanding of the invention, and to show how embodiments of the same may be carried into effect, reference will now be made, by way of example, to the accompanying diagrammatic drawings in which:

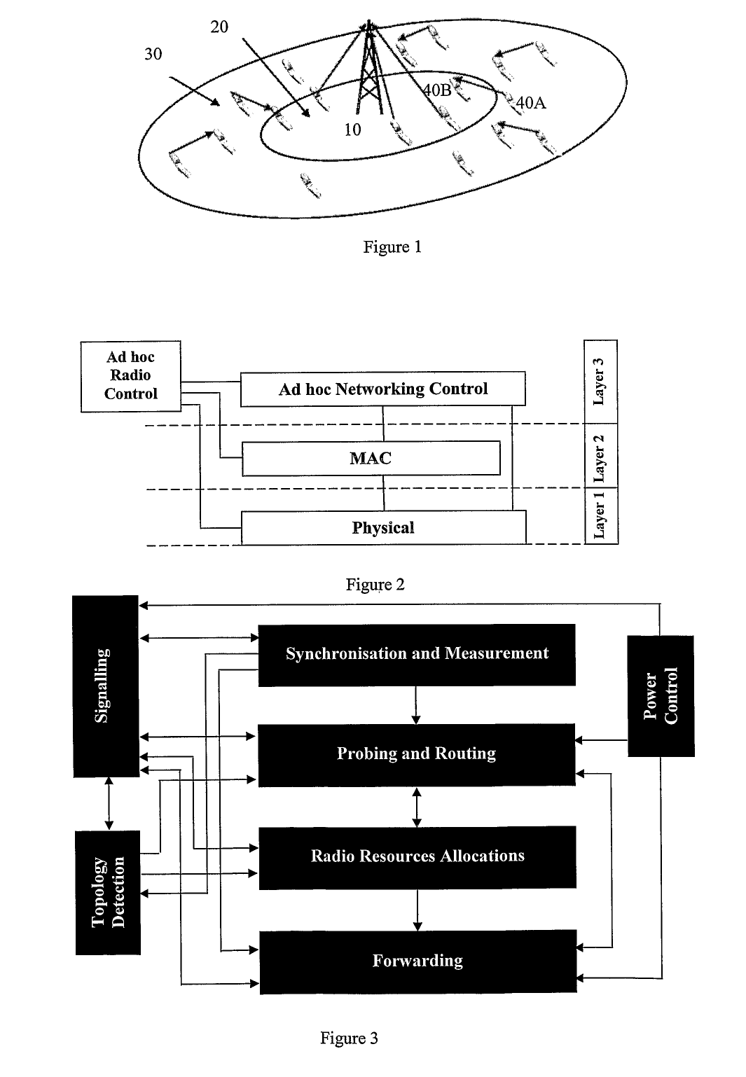

FIG. 1 shows a single cell 3G system combined with ad hoc communications in accordance with embodiments of the invention;

FIG. 2 is a block diagram showing the architecture of a protocol for implementing Ad hoc networking in accordance with an embodiment of the invention;

FIG. 3 is a schematic block diagram showing a functionality map for a protocol for implementing Ad hoc networking in accordance with an embodiment of the invention;

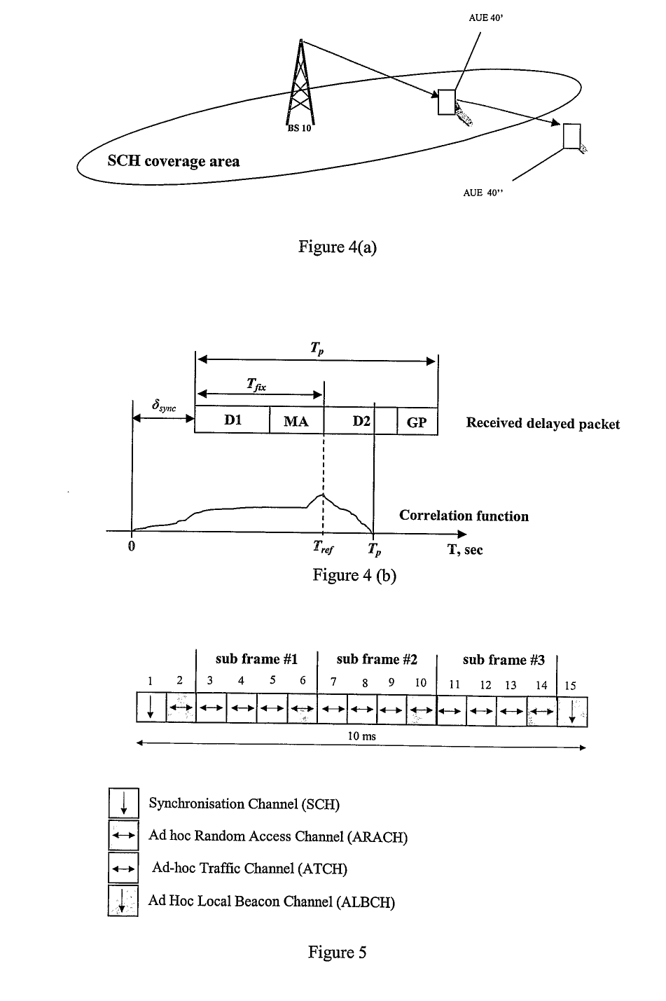

FIG. 4(a) illustrates a coverage area of a synchronisation channel, a user equipment which is inside that coverage area, and a further user equipment that is outside of that area and which itself requires synchronisation;

FIG. 4(b) illustrates synchronisation by detection of a maximum value within a correlation function;

FIG. 5 shows a frame structure for use in ad hoc networking;

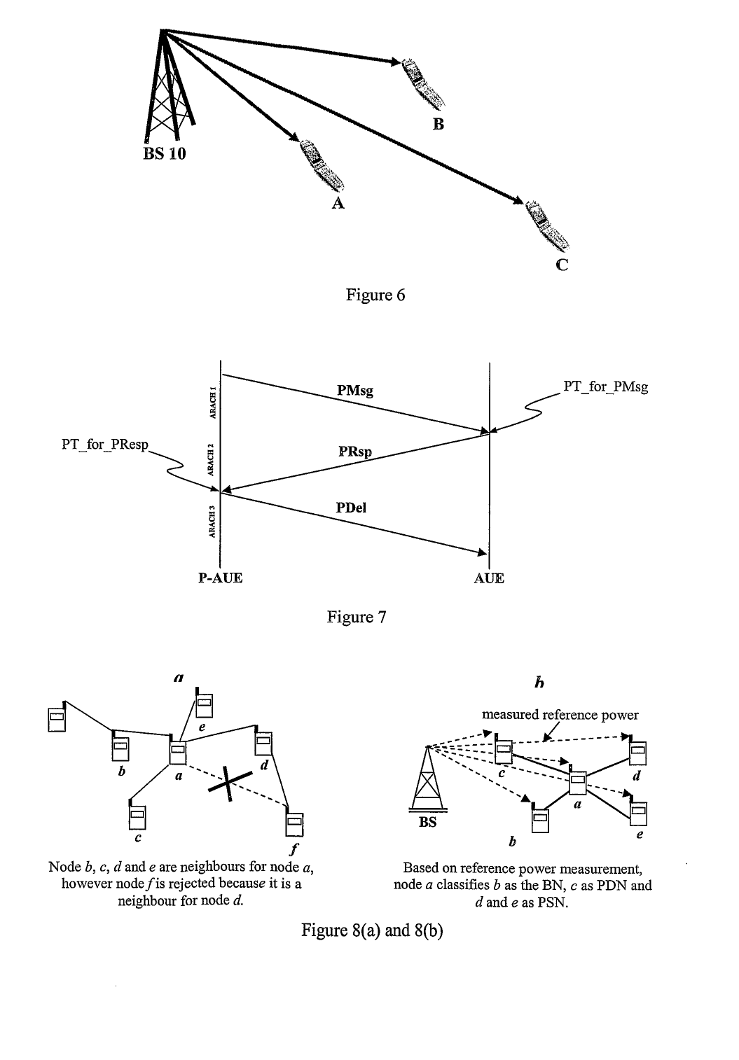

FIG. 6 illustrates relative positioning estimation based on measurement of reference power levels;

FIG. 7 illustrates a probing messaging strategy;

FIGS. 8(a) and 8(b) respectively illustrate the identification and rejection of 2-hop neighbours and the classification of neighbours of an AUE

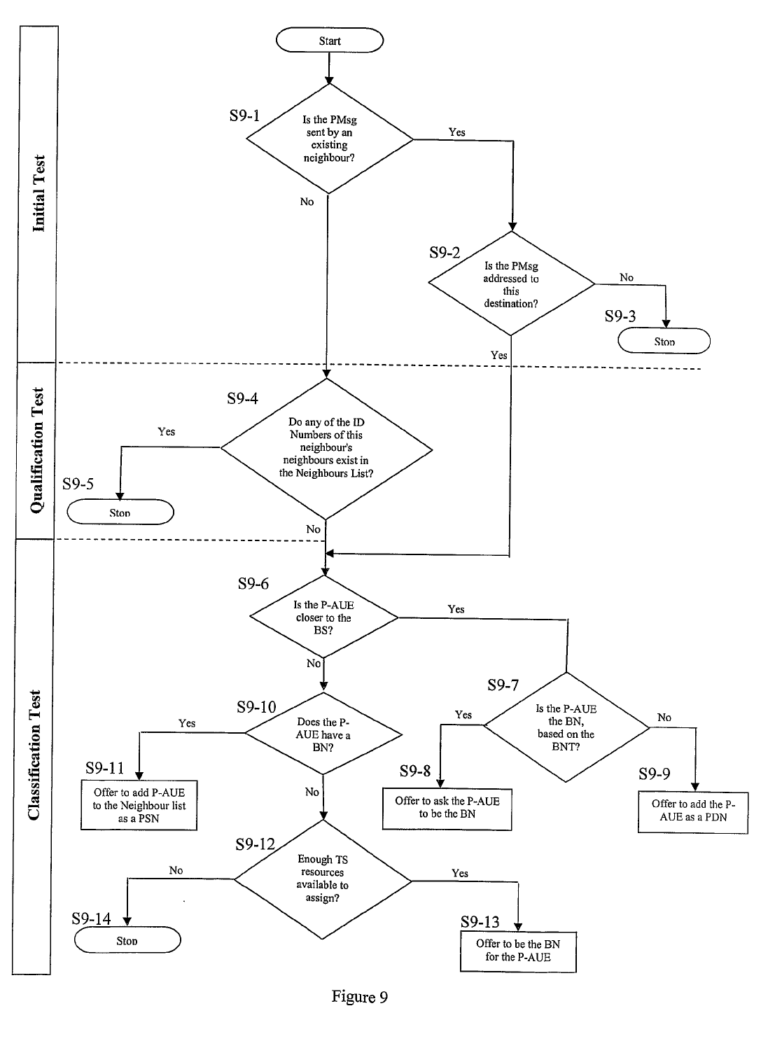

FIG. 9 is a flow chart illustrating a test procedure which is carried out by a neighbouring AUE on receipt of a probing message from a probing AUE;

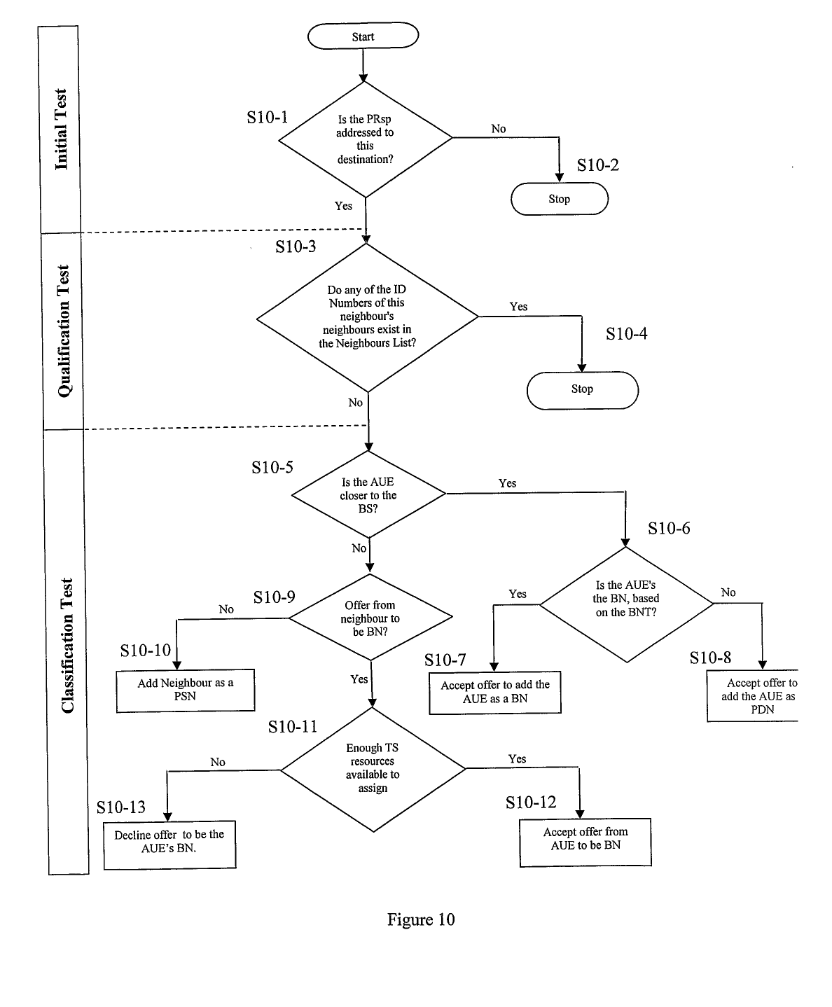

FIG. 10 is a flow chart illustrating a test procedure which is carried out by a probing AUE on receipt of a probing response from a neighbouring AUE;

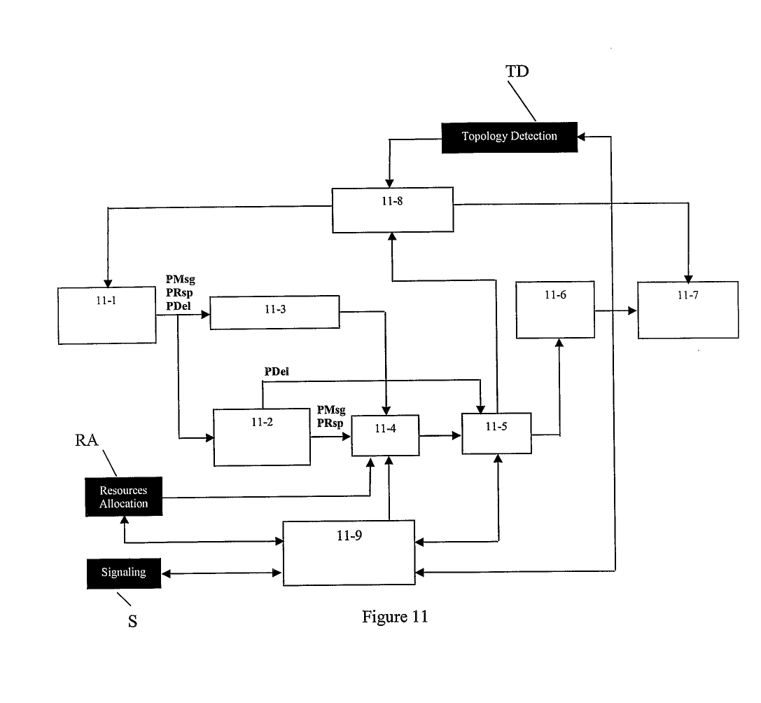

FIG. 11 is a functional block diagram summarising the probing procedure in overview;

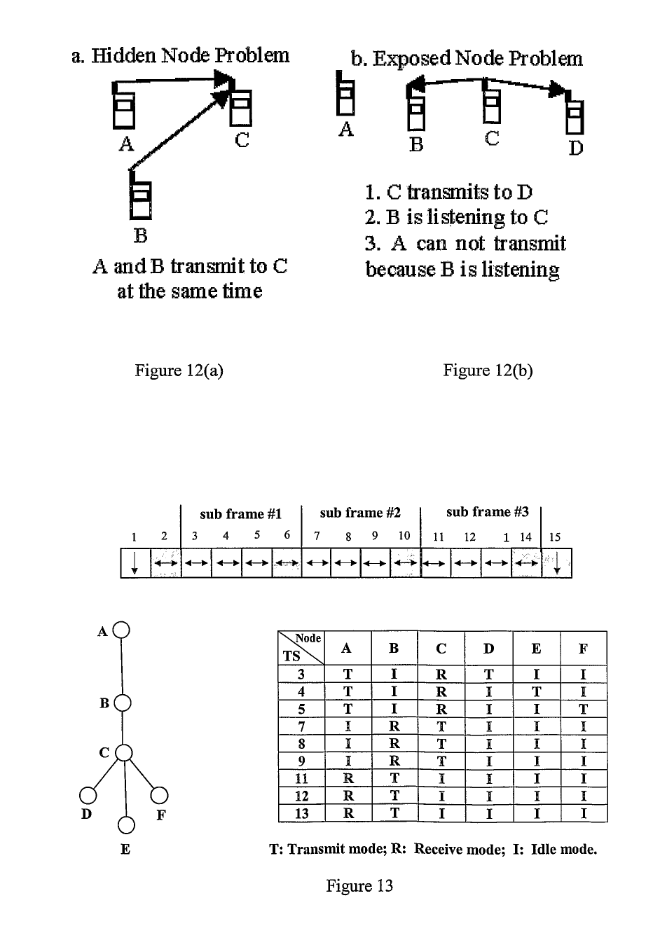

FIGS. 12(a), (b) illustrate hidden node and exposed node scenarios;

FIG. 13 illustrates timeslot allocation;

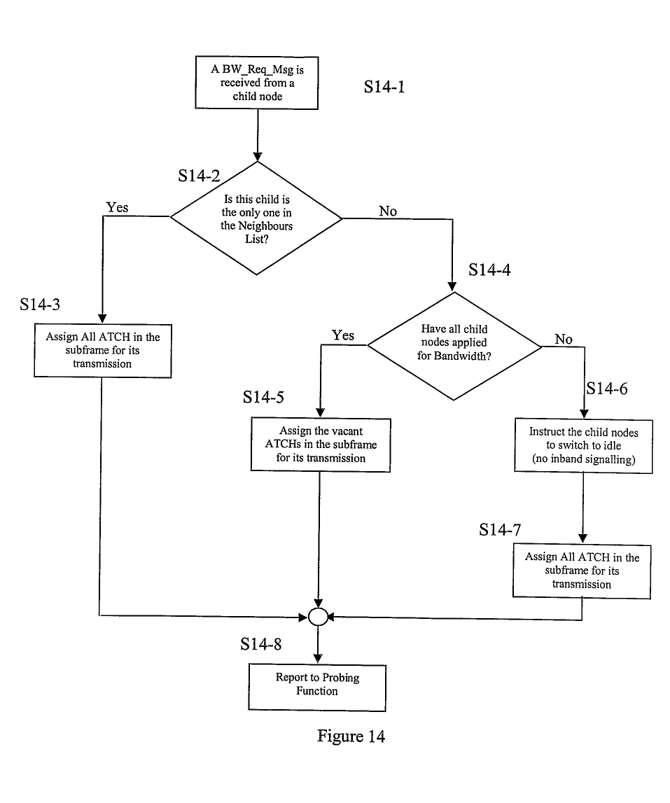

FIG. 14 is a flow diagram illustrating resource allocation strategy;

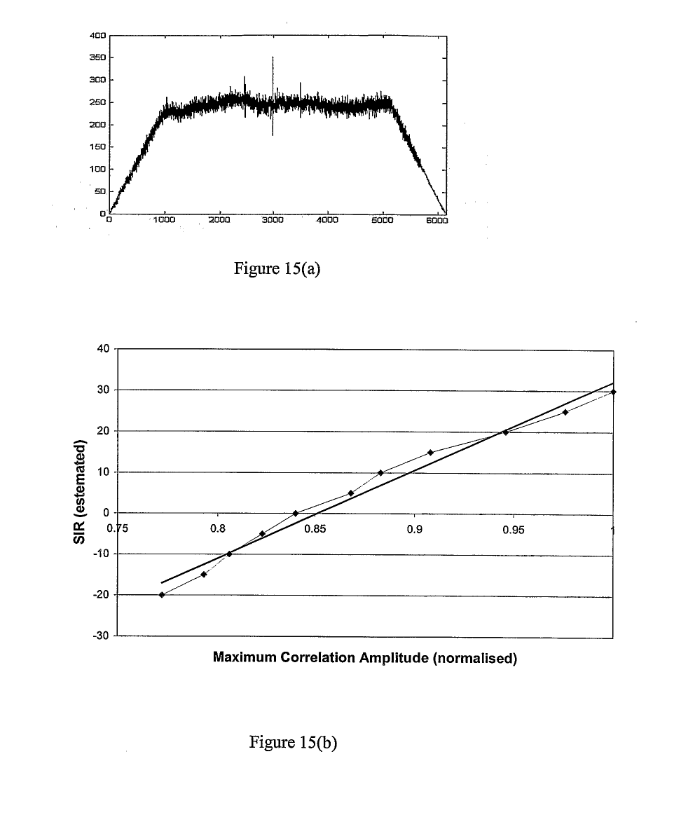

FIGS. 15(a) and 15(b) show a correlation function and amplitude from which a measure of Signal to Interference ratio (SIR) may be obtained;

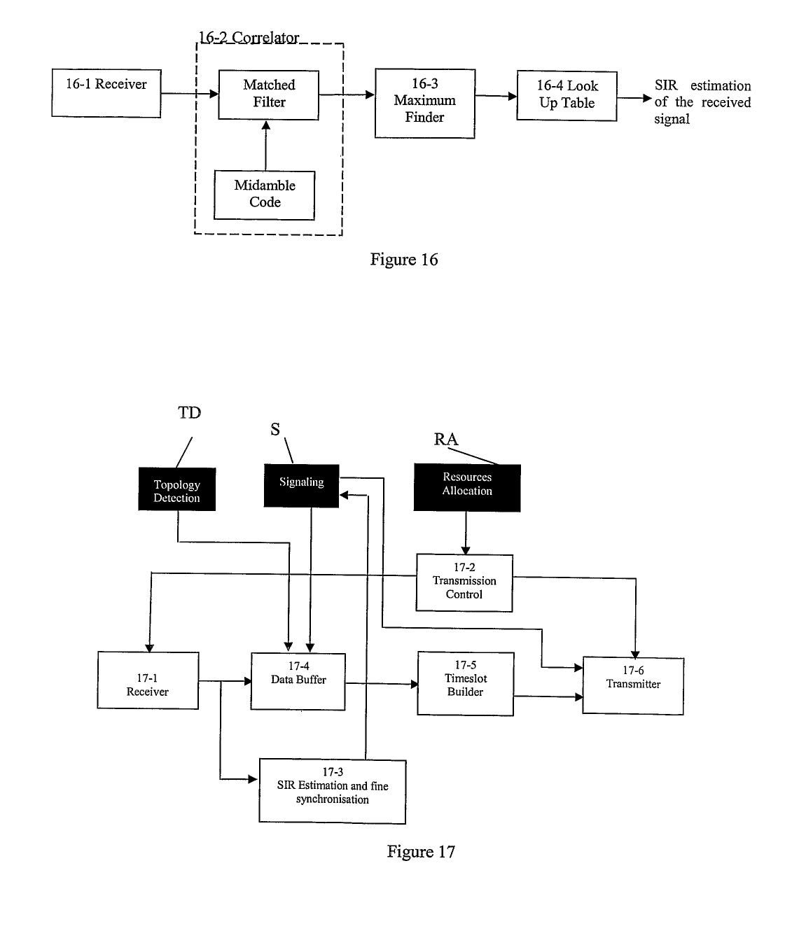

FIG. 16 is a block diagram illustrating how SIR may be determined;

FIG. 17 is a block diagram of the Forwarding function;

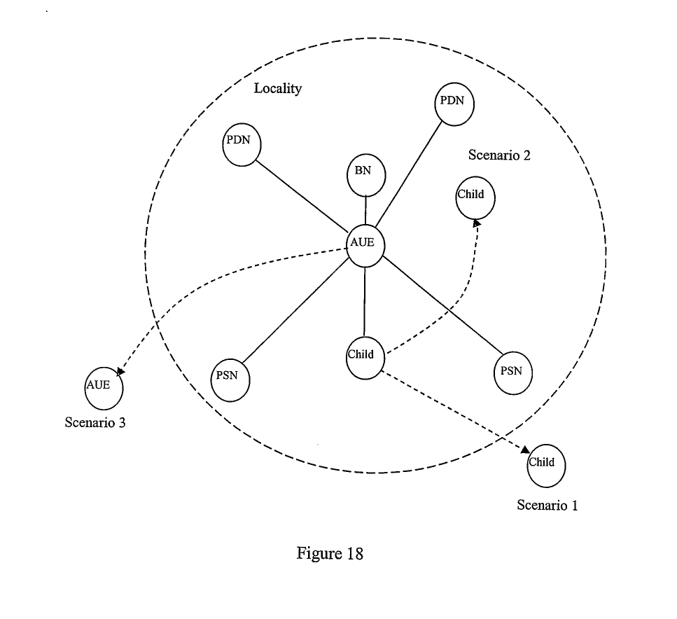

FIG. 18 illustrates topology change scenarios;

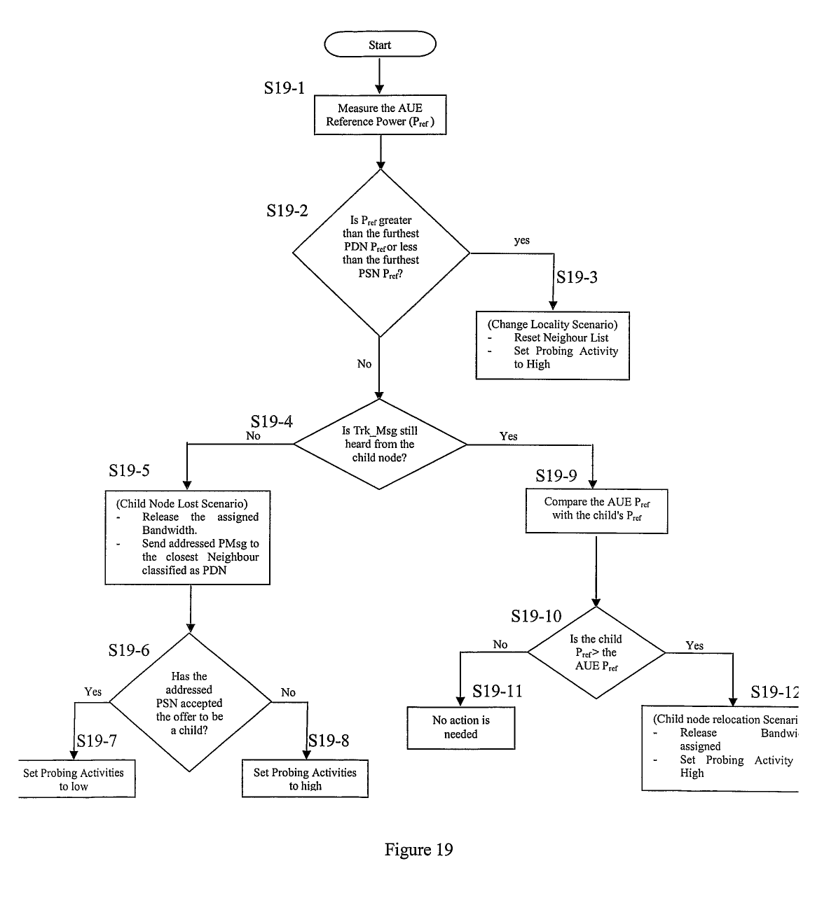

FIG. 19 illustrates a topology detection function mechanism;

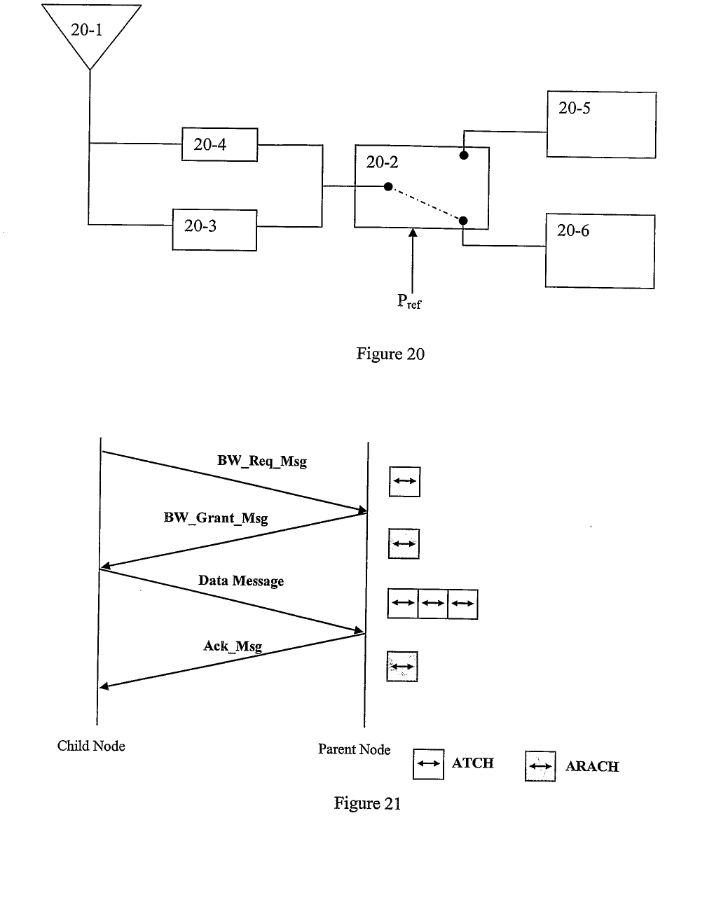

FIG. 20 illustrates a simplified hardware configuration for a handset; and

FIG. 21 illustrates a signalling strategy for resource allocation.

In this disclosure we will be referring to Ad hoc Networking Over UMTS Protocol by using the shorthand term ANOUP, which is the subject of this invention.

ANOUP is intended to combine ad hoc networking with the fixed wireless infrastructure provided by so-called 3G systems. The aim of this combination is to provide improved data rate capacity and coverage of the cellular system.

ANOUP can be considered as an extended framework for the 3GPP's (Third Generation Partnership Project) Opportunity Driven Multiple Access (ODMA) which is a transmission relay protocol to be applied to the 3G infrastructure. ANOUP is designed to provide ad hoc communications in the UTRA-TDD environment.

CDMA systems are characterized as interference limited systems in the way that the quantity of the users and the quality of the services provided by the networks are mainly governed by the background interference due to the multiplicity of users. Therefore, resources in CDMA systems are energy (power) allocated rather than frequency or time allocated.

Ad hoc networking is brought to the scene of the UMTS on the assumption that transmission through shorter links between transmitters and receivers would relax the interference problems so that cell coverage would be improved.

Ad hoc networking exploits the opportunistic gathering of wireless devices to set up an infrastructureless wireless communications arrangement between users to enable an otherwise out of reach location to connect with the a Base Station (generally referred to hereinafter as the BS), in the manner illustrated by FIG. 1.

In FIG. 1, there is shown a Base Station BS 10, an original coverage area denoted by a first region 20 bounded by an inner circle, an extended coverage area 30 bounded by an outer circle, and various users with Ad hoc user equipment (AUE) 40 positioned at random locations within the two areas.

The extended coverage area 30 is an area (possibly extending three times of area 20) in which there is still a good Down Link signal (from BS to AUE), but within which there is no direct Up Link path due to limitations in, for instance, transmitting power of the AUE itself, and/or interference considerations.

The general purpose behind the methods and systems of the invention is to extend the coverage of a network beyond the usual coverage. In the specific instance shown in FIG. 1, the aim is to allow users in the area 30 outside the original area of coverage 20 to communicate with the BS 10. This is achievable by relaying of messages, from ad hoc user equipment AUE1 40A, i.e. a handset, via a neighbouring AUE2 40B closer to the BS 10 and so on to the destination BS 10 itself. In the case where the first neighbour AUE2 40B is actually within the area of original BS 10 coverage 20, then the journey from source AUE1 40A to destination BS 10 is a one hop journey. However for a source further away, then the journey from source to destination may comprise a number of hops before the message can be relayed to the BS 10.

In ANOUP, network, MAC (Medium Access Control), and physical layer issues such as synchronisation, routing and more (to be discussed later) need to be addressed as each AUE 40 is effectively a self-organised entity which has to perform many different functions in the absence of control from the Base Station BS 10.

Referring to FIG. 2, which shows the architecture of the suggested ANOUP protocol from a networking point of view, ANOUP is a multi-layer problem. A physical layer is responsible for maintaining communications on the link level to perform packet reception and transmission. The MAC layer executes sets of algorithms and strategies related to sharing the radio resources and collision avoidance of relayed messages. A network layer performs calculations and approximations that are vital to determine the necessary decisions for routing the radio packets toward the BS.

Here we summarise the functions assigned to each layer:

i. Physical Layer (L1)

Receiving the relayed data from a neighbour.

Transmitting the relayed data to a host.

Buffering the relayed data prior to retransmission.

Timeslot building (performing channel coding, spreading and mapping according to the standards of the 3^{rd} Generation Partnership Project (3GPP))

Performing measurements essential for layer 2 and 3 functionalities.

Performing frame and timeslot synchronisation.

ii. Medium Access Control (MAC) Layer (L2)

Assigning resources i.e. timeslot and spreading codes.

Contorting the given resources i.e. timeslot and spreading codes.

Performing spreading codes selection for an ARACH channel—to be discussed later.

Setting up an ALBCH channel—to be discussed below.

Reporting resources status to L3.

iii. Network Layer (L3)

a. Ad hoc Networking Control (ANC)
Performing connectivity maintenance (probing).
Performing topology discovery.

Performing ad hoc routing.
b. Ad hoc Radio Link Control (ARLC)
Performing signalling.
Performing power control.

FIG. 3 shows the functional map of the ANOUP protocol, the functionalities including: synchronisation and measurement, probing and routing, radio resources allocation, forwarding, power control, topology detection and ad-hoc signalling.

In brief, the ad hoc user equipment AUE1 40A synchronises itself with the BS 10 in order to acquire timeslot and frame synchronisations that will enable the AUE to listen to the broadcast channel (transmitted over Timeslot 1 in the ANOUP time frame) and measure the reference transmit power which is to be used to perform different functions. Once synchronisation and measurement are acquired, AUE performs probing activities to build up a list of neighbours. Using the information gathered through probing the AUE1 can work out the relative positions of its neighbours with respect to the BS 10 to come to a routing decision for its own. Having executed the probing function, the radio resources (which are defined in timeslots and spreading codes) are allocated and controlled in a decentralised fashion where the receive node is given the superiority to control the media for transmitting nodes. Power control is also considered in the protocol by providing a Signal to Interference Ratio based power control on transmission power to reduce interference. Ad hoc signalling and topology detection functions takes care of link maintenance and assurance messaging between transmit node (AUE1 40A in FIG. 1) and receive node (AUE2 40B in FIG. 1).

Before discussing the individual elements of the protocol in more detail, it will be useful to refer to FIG. 5 which shows a possible frame structure for ad hoc signalling via ad hoc networks over UTRA-TDD. The structure as shown consists of 15 timeslots (TS) and lasts a total of 10 ms. In the frame structure, there are shown frame types for a Synchronisation Channel (SCH) (which carries synchronisation information and a beacon channel from the BS 10 for synchronising between nodes), an Ad hoc Random Access Channel (ARACH) (for carrying probing messages and responses and “random access” signalling messages between AUEs), an Ad hoc Traffic Channel (ATCH) (for carrying relayed data messages between AUEs) and an Ad hoc Local Beacon Channel (ALBCH) (for carrying “inband” signalling between AUEs). These various channels will be referred to again, in the relevant descriptive portions below.

In the following pages, each of the functionalities set out in the protocol of FIG. 3 will be described in detail.

Synchronisation and Measurement

a. Synchronisation

All AUEs must be synchronised with the BS 10 on the frame and timeslot level as asynchronous reception of transmitted messages may result in message loss and/or excessive interference at nearby receiving ends.

Synchronisation is acquired in two ways: (i) Listening to the SCH channel, which is a beacon channel transmitted by the BS 10 and carries synchronisation information; and (ii) If the SCH cannot be heard then an AUE can be synchronised using a procedure which we refer to hereafter as the Cooperative Ad-hoc Synchronisation Scheme (CASS).

CASS extends the synchronisation by means of peer-to-peer synchronisation. In CASS an asynchronously operating AUE can synchronise itself with an AUE which is itself synchronized with the BS10.

FIG. 4(a) shows a cell comprising a base station BS 10, a first AUE 40′, a second AUE 40″, and an area of coverage of a synchronising signal SCH emitted by the base station BS10. In this figure, the second AUE 40″ is (initially) an asynchronous receiver which is outside of the range of the SCH channel transmitted by the BS 10, whereas the first AUE 40′ is within range of the SCH channel and therefore is synchronised directly. Because direct synchronisation is not available, the asynchronous receiver AUE 40″ listens to the radio medium hoping to receive a packet transmission from a transmitting synchronized (with the BS) AUE, such as AUE 40′.

To explain the synchronisation process of CASS properly, an understanding of the packet transmissions within ANOUP is needed. Essentially, there are three types of packet transmission used to facilitate Ad-hoc communications: a Data Message Packet for carrying user data; a Probing Message Packet for carrying probing messages (to be explained later); and a Signalling Message Packet for carrying signal messages. All packets conform to a standard UTRA-TDD packet format being a combination of three parts: two data fields separated by a midamble field, the second data field being followed by a guard period. The data field carries the user's payload data, the Midamble (MA) field contains the training sequence that is used to estimate the channel impulse response as a part of the data recovery phase at the receiver, and the guard period is used to allow for any inaccuracies in time synchronisation and propagation delay.

When it comes to the Cooperative Ad-hoc Synchronisation Scheme proposed, the scheme works by, as soon as the asynchronous AUE receiver 40″ switches on, starting to correlate the bursts it receives with a predetermined midamble code for the length of a time slot. The correlation function will have a maximum, this maximum corresponding to the end of the midamble field in the received burst as shown in FIG. 4 (b). Once the time that the maximum occurs is known, the asynchronous receiver 40″ can calculate the synchronization delay, δ_{sync}, by subtracting the referenced correlation time, T_{ref}, from the fixed time, T_{fix}, which is the summation of the duration of the first data field (D1) and the midamble (MA), i.e. δ_{sync}T_{ref}−T_{fix}.

In this manner, each non-synchronised AUE 40″ that is out of range of the beacon transmitted by the BS10, attempts to synchronise itself with an already synchronised neighbour by listening out for packets transmitted by that neighbour and, on the basis of known information it then performs a correlation function and synchronisation calculation to bring about synchronous operation. As an ongoing procedure, peer-to-peer synchronisation may also be used for perfecting the synchronisation between transmitting and receiving AUEs. In this manner CASS can assure synchronisation within an area far beyond the SCH coverage area.

b. Measurements

In ANOUP, it is important for the receive node to always be geographically located in the direction of the BS so that the relayed message advances one hop every timeslot toward the BS, until it reaches the final destination (i.e. the BS). This will prevent the messages from being routed further away from the BS or from being routed within a closed loop.

To execute the probing, topology detection and signalling functions (which will be described presently), an AUE needs to measure the transmit power on the beacon channel of the BS 10.

Beacon channels are transmitted with the reference power without beam forming. The Primary Common Control Physical Channel (P-CCPCH) which is located on the synchronisation timeslots (TS1 in an ANOUP radio frame disclosed later) uses a spreading factor of 16. As will be appreciated, the accuracy of the power measurement will affect other functionalities of the AUE.

Probing

The probing procedures will now be discussed in more detail.

Probing is a procedure in which a Probing Ad hoc User Equipment (P-AUE) such as AUE1 40A of FIG. 1 whispers to its neighbours and listens to others in its vicinity to build up a list of neighbours. An AUE that performs a probing function is referred to herein as a Probing Ad hoc User Equipment P-AUE. A neighbour is defined as an AUE that is only one hop distant from the P-AUE. The main objective of probing is to find the closest neighbour in the direction of the BS 10—this neighbour is known as the Best Neighbour BN. The BN is the only neighbour that an AUE addresses whenever it has messages to forward and is the minimum requirement essential to maintaining connectivity in the Ad hoc path between an AUE and the BS. We will also refer here to the BN as the “Parent Node” and the AUE that addresses it as the “Child Node”.

Probing also is employed to react to topology changes and update the shortest link for message forwarding. To make use of the existing cellular infrastructure, ANOUP uses a measurement of the transmit power of the Base Station BS 10 gained by monitoring of the “beacon channel” of the BS 10 and this measurement is revealed in a Probing Message PMsg (from the P-AUE) and a Probing Response PRsp (to the P-AUE from its neighbour). The P-AUE uses this measurement of the reference power on the beacon channel to estimate the relative positions of its neighbours with respect to the BS 10. Upon that estimation, the AUE is able to negotiate a probing deal with its neighbours and will aim to forward its message to its nearest neighbour in the direction of the BS 10. Forwarding to the nearest neighbour in this fashion keeps transmit power at the P-AUE—and hence battery usage and background interference—as low as possible.

As already mentioned, a neighbour is defined as the AUE which is a one hop distance from the source AUE. Throughout the probing procedure an AUE exchanges information (via Probing Messages and Responses) to obtain a picture of the surrounding neighbourhood. Based on the information received, the AUE decides to which neighbour it could forward its message to and from which neighbours it may receive messages. The ad hoc random access channel (ARACH) of FIG. 5 is the physical channel assigned to carry the probing messages and their responses.

In Probing the AUE has to classify the neighbours into potential recipients or potential sources and, secondly, the AUE has to decide from the list of potential recipients, which of them is the Best Neighbour BN. By definition the BN is the closest neighbour located in the direction of the BS 10 and therefore the BN has to be located geographically in the direction of the BS and it has to have the shortest hop amongst the PDNs. The geographical location with respect to the BS is based on the reference power comparison however the link length estimation is based on two parameters; the knowledge of the neighbour's transmit power, which is revealed in the probing message, and the SIR estimation of the received probing message as it will be shown below. There can only be one BN for an AUE, however, an AUE can itself be a Best Neighbour for more than one AUE—a maximum of 3 child nodes per parent node in the preferred embodiment.

To achieve the probing objectives ANOUP makes use of the existing cellular infrastructure and suggests using the power transmitted from the BS 10 on the beacon channel as a mean to estimate the relative positioning of an AUE with respect to its neighbours by comparing the power of the signal it receives from the beacon channel to the power received by its neighbours. On the basis of that comparison, the AUE will be able to decide whether the neighbour AUE is situated closer to or further from the base station with reference to its own position.

FIG. 6 explains the concept of relative positioning. Here, there are shown three AUEs A-C and the Base Station BS 10. In this scenario, the reference power level at AUE B is less than the reference power level at AUE A and greater than at AUE C. This implies that AUE A is situated closer to the BS 10 than AUE B and that AUE C is further away from the BS 10 with respect to AUE B. On the basis of this comparison, all AUEs are able to negotiate probing deals.

The accuracy of the relative positioning estimation depends on the propagation conditions (slow fading) between each AUE and the BS 10. If there is a difference in slow fading propagation conditions between the BS 10 and each of the AUEs, then errors in relative positioning may occur.

The specific probing messages used to conclude a deal in the preferred embodiment will now be considered with reference to FIG. 7. The probing procedure is as follows, and is achieved in three steps:

1. P-AUE broadcasts a general probing message PMsg to all surrounding neighbours on the ARACH channel, where the probability of successful message reception is governed by the background interference, caused by other probing users and the probability of message collisions. The PMsg is broadcast using randomly selected spreading codes among a set of 16, 8 or 4 spreading codes, each with 16, 8, and 4 Spreading Factor (SF) respectively

2. Depending on the chances of receiving the PMsg at an acceptable signal to interference ratio (SIR) and after executing a Probing Test (PT) for Probing Message (PT_for PMsg), the potential neighbour AUE responds to the specific probing AUE which initiated the PMsg on the next ARACH by sending a Probing Response PRsp on one of the available spreading codes.

3. Depending on the chances of receiving the PRsp and after having executed a Probing Test for PRsp (PT_for_PRsp), the P-AUE sends, on the next ARACH, a probing deal (PDel) to the specific AUE that initiated the Probing Response PRsp to confirm the deal.

The PT_for_PMsg or PT_for_PRsp comprises four parts i.e. the Initial Test (IT), the Qualification Test (QT), the Classification Test (CT) and the Best Neighbour Test (BNT). The IT makes sure that the probing message is addressed to the right destination. The QT is designed to make sure that only one hop neighbours are added to the Neighbours List, the CT is designed to classify future neighbours according to the routing strategy, while the BNT is designed to elect the BN.

In order to update the Neighbours List, the IT part of the PT_for_PMsg and PT_for_PRsp is executed to make sure that the AUE in question doesn't only reply to already existing neighbours in its own Neighbour List. That is beneficial in two ways:

1. It reduces the amount of interference and the possibility of collisions over the ARACH; and

2. It restricts responses to just the new potential neighbours visiting the vicinity, and therefore keeps the demands on both itself and on non-addressed AUEs as low as possible.

As mentioned above, the QT rejects all two hop neighbours, and the difference between one and two hop neighbours is illustrated and discussed here with reference to FIG. 8(a).

Referring to FIG. 8(a), there are shown a number of nodes “a” through “f”, where node “a” is the Probing AUE. From the figure it can be seen that whilst nodes “b” through “e” are single hop neighbours of “a”, node “f” is to be rejected as it is already listed as a neighbour of “d” in the Neighbour List of “d”. Rejection in this manner saves on resources for “a”, “f” and “d” and avoids wasting of computational power.

To execute the QT correctly, the P-AUE will need to know the unique identification number (ID) of its own neighbours and the IDs of their neighbours and whenever it appears that a prospective neighbour has an ID which is already resident in the Neighbour List of one of the P-AUE's neighbours, it then excludes this prospective neighbour from its own Neighbour List.

Once the QT is executed, the CT takes place to classify the neighbours of a P-AUE into one of three classes by means of the relative positioning and SIR estimation.

Referring to FIG. 8(b), various neighbours “b” to “e” of a Probing AUE “a” are shown. These neighbours will each fall into one of the classes of Potential Source Neighbour (PSN), Potential Destination Neighbour (PDN) and Best Neighbour (BN).

A PSN is a neighbour that could forward messages to the P-AUE (for instance, nodes “d” and “e” being further from the BS than node “a” are PSNs).

A PDN is a neighbour that could possibly be a target for the P-AUE to forward its message to (for instance, nodes “b” and “c” being closer to the BS than node “a” could be PDNs).

The BN is (as already discussed) the one of the PDNs that has shortest link in the direction of the BS—generally, this means that it will be the closest PDN to the P-AUE (in this case node “b”).

The BNT is executed to estimate the shortest link between the AUE and its PDNs. This test will come out with the result upon which the AUE can decide which of its PDN is the BN and how relatively each of them are distanced. The inputs of the BNT are the transmit power of each PDN which is revealed in the probing message and the SIR of the received probing message which is estimated as will be shown below. The BNT is based on a simple SIR model that is expressed as follow; SIR (dB)=Pₜ(dB)−10 log r^{B}−P_{I}(dB), where Pₜ is the transmit power of the probing message, r is the distance between the prospective neighbour and the AUE, B is the pathloss exponent (usually B=4) and P_{I} is the received interference power by other interfering AUEs. The BN is elected by comparing the SIR of the prospective PDN and each of the existing PDNs in the neighbours list separately. As an example to illustrate the BNT, if SIR₁ and SIR₂ denote to the signal to interference ratio of the prospective PDN and an existing PDN respectively then SIR₁−SIR₂=ΔSIR(dB)=ΔPₜ (dB)+40 (Log r₂−Log r₁), where ΔPₜ (dB)=Pₜ₁(dB)−Pₜ₂(dB), therefore:

Log r₂−Log r₁=(ΔSIR(dB)−ΔPt(dB))/40 (1)

The sign of the right hand side of equation (1) indicate whether r₁ is greater (or smaller) than r₂ and the magnitude of equation (1) is used to sort the PDNs with respect to their closeness to the AUE.

The CT_for_PMsg is different from the CT_for_PRsp. The CT_for_PMsg which is executed at the prospective neighbour aims to find out what offer best suits the P-AUE from its point of view. However, the CT_for_PRsp looks into which offers it is able to accept from its point of view so that the P-AUE can then finalise the deal.

Looking at this in more detail, the PT_for_PMsg and PT_for_PRsp are shown in FIGS. 9 and 10 respectively.

Regarding FIG. 9 now, there is shown a flow chart illustrating the procedures carried out at each prospective neighbour upon receiving a Probing Message PMsg from a Probing AUE (P-AUE).

In a first step S9-l during the initial test (IT) phase, the prospective neighbour node checks to see if the message received comes from an existing neighbour (one already on its “neighbour list”).

If the PMsg does come from an existing neighbour, then the node checks in a step S9-2 to see whether it has been specifically addressed in the PMsg and, if not, then it will stop processing the message and the PT_for_PMsg will end at step S9-3.

If at step S9-1, the PMsg was determined not to have come from an existing neighbour, then the Qualification test (QT) phase initiates in step S9-4 to check on whether any ID numbers of the neighbours of the P-AUE already exist in the “neighbour list”—i.e would this node become a two hop node?—and, if so, then processing of the PT_for_PMsg stops at step S9-5.

If, however at step S9-4, the relevant ID does not appear in the neighbours list OR at step S9-2 it was found that the PMsg was specifically addressed to this node, then at a step S9-6 the Classification Test (CT) phase initiates with a check on whether the P-AUE is closer to the BS than it is.

If in step S9-6, the P-AUE is found to be nearer the BS, then in step S9-7 it is checked whether the P-AUE is the BN by executing the Best Neighbour Test as shown above, if it the BNT comes up with the answer “yes” that the P-AUE is the BN, then it sends an offer in step S9-8 asking the P-AUE to be its Best Neighbour whereas, if the result of the BNT comes out No answer, then the node offers to add the P-AUE as a PDN in step S9-9.

If in step S9-6, the P-AUE is found to be further away from the Base Station, then in step S9-10, the AUE checks whether the P-AUE has a Best Neighbour already. If the P-AUE does have a BN already, then in step S9-11 the prospective neighbour offers to add the P-AUE to its own neighbour list as a Potential Source Node.

On the other hand, if in step S9-10 it is determined that the P-AUE does not have a BN, then in step S9-12 the prospective neighbour makes an internal assessment to see if it has enough resources available to be able to assign them in a Best Neighbour role and, if it does then at step S9-13 it makes an offer to be the BN for the P-AUE—whereas if insufficient resources are available (e.g. it is already a BN for three P-AUEs), then the procedure stops at step S9-14.

Having described the PT_for_PMsg in FIG. 9, the PT_for_PRsp (performed by the P-AUE in response to receiving the PRsp) will now be discussed in relation to FIG. 10.

In an Initial Test phase, the P-AUE checks in step S10-1 to see if the PRsp received is addressed to it and, if not, then the PRsp is ignored and the procedures stop at step S10-2. Otherwise, the Qualification Test commences at step S10-3 with a test to see if any of the ID numbers of the Neighbour List of the responding prospective neighbour already exist within the Neighbour List of the P-AUE—if so, then this shows the prospective neighbour to be a two-hop neighbour and the procedures are stopped at step S10-4.

If there are no common neighbours found at step S10-3, then the Classification Test phase is entered by performing a test at step S10-5 to check on whether the prospective neighbour is closer to the BS than the P-AUE—if so, then in step S10-6 it is checked whether the prospective neighbour is the BN based on BNT as shown above. If the prospective neighbour appeared to be the BN, then in step S10-7 an offer from the prospective neighbour (if issued at step S9-13) to be the BN for the P-AUE will be accepted so long as the prospective neighbour has sufficient resources for it to be able to assign. However, if the result of the BNT is No (or no offer to be the BN was issued at step S9-13 and the P-AUE was offered the status of a PSN at step S9-11), then in step S10-8 the P-AUE accepts to add the prospective neighbour as a PDN.

If in step S10-5, the prospective neighbour is determined as being further away from the BS than the P-AUE, then the Classification Test phase continues at step S10-9 by determining whether or not the P-AUE has received an offer (i.e. request) from the prospective neighbour for the P-AUE to be its BN, if not, then at step S10-10, the P-AUE will add the prospective neighbour to its own list as a PSN. If however, at step S10-9 the prospective neighbour has offered to ask the P-AUE to be its BN, then at step S10-11, the P-AUE does an internal assessment to see if it has enough resources available to be able to assign them in a Best Neighbour role and, if it does, then at step S10-12 it accepts to be the BN for the prospective neighbour—whereas if insufficient resources are available (e.g. it is already a BN for three P-AUEs), then the procedure stops at step S10-13 by declining the offer to be the BN.

As will be evident from the above, probing messages in the probing deal negotiation have to comprise the following elements:
The distinctive ID number of the P-AUE.
The measurement of the received power on the beacon channel.
The ID numbers of the neighbours in the neighbours List.
The result of the PT_for_PMsg or PT_for_PRsp.
The transmit power level of the probing message (used for SIR estimation).
Whether the P-AUE has a BN or not.
Whether the P-AUE had set up the ALBCH.

The Neighbour List of an AUE consists of a minimum number of neighbours of each class as following:
One neighbour classified as BN.
Two neighbours classified as PDN.
Two neighbours classified as PSN.
One child node (a child node is the neighbour which sees the AUE as its BN)

The Probing activity level for an AUE is influenced by the shortage in the number of AUE neighbours in the Neighbours List and commands from Topology Detection Function. The degree of shortage determines the probing activity level.

The ANOUP protocol proposes three probing activity levels:
High Probing Level: The AUE probes at high level whenever it has no neighbour in its list classified as BN. At this level of probing, the AUE alternatively transmits and listens to probing messages on every ARACH channels.
Moderate Probing Level: The AUE probes at moderate level whenever it has a shortage in the predefined minimum number of AUE neighbours classified as PDN. At this level of probing, the AUE more frequently listens and less frequently transmit probing messages on the ARACH channels.
Low Probing Level: The AUE Probes at low level whenever it has a shortage in AUE neighbours classified as PSN. At this level of probing, the AUE only listens to probing messages on the ARACH channels.

FIG. 11 shows the block diagram of the probing function, and how the probing function interfaces with other functionalities such as Resource Allocation “RA” (to be described next), Signalling “S” and Topology Detection “TD”.

As shown in FIG. 11, there are provided functional blocks 11-1 through 11-9.

Block 11-1 represents the Probing Messages Receiver function, whereby the various messages such as PMsg, PRsp and PDel (as described above) are received at the baseband level. Block 11-2 is the Probing Message Selector and this receives the messages from block 11-1 and then classifies those messages according to type—PDel messages are conveyed straight to Decision Unit block 11-5 (described shortly), whereas a PMsg or a PRsp would be taken directly to block 11-4 which is a Probing Test function for applying the PT_for_PMsg test or the PT_for_PRsp test respectively.

The Decision Unit 11-5 receives the results of the probing tests and also any PDel messages and with reference to the Neighbours List (represented by functional block 11-9) makes any pertinent decisions such as deciding how to respond to the PMsg or PRsp, removing or adding neighbours or reacting to shortages in the Neighbours List by setting the appropriate probing activity level.

Block 11-3 represents the SIR estimation function which estimates the Signal to Interference Ratio and is used in the Probing Test Functions when assessing the relative positions of neighbours and coming to routing decisions.

Block 11-6 represents the function of Probing Message Composer which composes messages according to whatever decisions are made by the Decision Unit 11-5, these messages are thereafter mapped and made ready for transmission on the ARACH by Probing Message Transmitter 11-7. The Probing Message Transmitter 11-7 is also connected to a Probing Activities Control function block 11-8 which controls the probing activities of the AUE over the ARACH channels and reacts to requests for probing activities from Topology Detection functions and from the Decision Unit 11-5.

The Neighbours List 11-9 contains details of the neighbours of the particular AUE classified according to their reference power measurements and SIR levels into the various categories of PSN, PDN, BN etc. This functional block supports the core functions of the protocol. The Decision Unit 11-5 can both add or remove neighbours to/from the list, whilst the Topology Detection functional block and the Signalling block are able only to remove neighbours. The Topology Detection function may reset the Neighbour list in the event of a detected topology change.

Routing

Where Probing is the means by which each node builds a picture of its surrounding environment from a topological point of view, Routing is the mechanism through which the next hop of the relayed message is decided.

The Routing decision depends entirely upon the outcome of the Probing procedure. Due to the limitations in node transmit power and the nature of the CDMA air interface, the AUE will only forward its messages to its own Best Neighbour and in the case where a BN is lost, messages are re-routed to the next best neighbour as defined according to reference power and SIR measurements given in the PDN section of the Neighbour List.

Resource Allocation

The resource allocation procedures will now be discussed in more detail.

Assigning CDMA radio resources in a wireless system requires frequent monitoring of the generated interference in frequency, time, and code domains. Any loss in monitoring, reporting or reacting, results in performance degradation. This problem is broadened in the context of ad hoc networking as packet collisions arise due to hidden and exposed nodes.

Two nodes are hidden from one another when they try and both forward their messages to the same receive node at the same time (illustrated in FIG. 12(a)). In the case that a parent node has more than one child hidden from one another, the parent node avoids potential collision problems by allocating different time slots to its children to prevent collisions.

The exposed node problem is illustrated in FIG. 12(b) and it is another source for collisions in ad hoc networking. A node such as node B in FIG. 12(b) is exposed whenever it is busy listening to a neighbour's transmission to a third party node, instead of listening to the neighbour which is actually addressing it—here, B is listening to C, while C transmits to D, meaning that A cannot transmit to B. This problem is mitigated in ANOUP by the introduction of an idle mode (i.e. where a node is neither transmitting nor receiving) so that the exposed node is forced to become idle whenever its parent is transmitting. Therefore, the parent node will not only inform the child nodes what time slot they may transmit on, but also on which time slot they have to switch to the idle mode.

Random code assignment leads to packet collisions, and the degradation worsens as the number of transmitting nodes increases. This does lead, however, to increased signalling overheads as well as the need to apply a strict power control regime to deal with the “near far” effect. This problem is alleviated in ANOUP by the receiving node assuming responsibility for code allocation to the transmit nodes.

The limited facilities at the AUEs and the opportunistic nature of the system let's us consider the problem of resource allocation as being one of timeslot allocation and spreading code allocation.

Resource allocation in ANOUP is decentralized, with the AUEs themselves assigning the resources of the UTRA-TDD network in the absence of the authority of the Base Station BS 10.

Spreading codes and timeslots have to be allocated in a way that prevents collision of the transmit messages at the receiving AUE.

The ANOUP protocol makes all spreading codes available to the transmitter, which addresses only one receiver at a time. This increases the transmission capacity for the transmitter and eases the complexity at the receiver, since a single user detector can be used instead of a more complex multi-user detector as all codes pass through the same propagation channel.

With the frame structure shown in FIG. 5, an Ad hoc Random Access Channel (ARACH) and an Ad hoc Traffic Channel (ATCH) were introduced—ARACH being used for probing messages and signalling between AUEs, whilst ATCH is used for relaying the messages of AUEs. In the case where an AUE has more than one child node, then the parent sets up the Ad hoc Local Beacon Channel (ALBCH) so that the parent can separately address each child in a specific frame (note—only one sub frame, three timeslots, is available for assignment to children and in the case where there is more than one child, then the sub frame is divided between them) to pass on its instructions regarding resource allocations etc.—whilst compelling the non-addressed child or children to be idle.

Time slots, in ANOUP, are allocated by the receive node AUE2 40B (parent) to the transmit node AUE1 40A (child). So that if AUE1 wants to forward its message to AUE2, then AUE2 assigns an ATCH timeslot for AUE1 to transmit. This allocation scheme ensures that an AUE will not perform simultaneous transmission and reception.

FIG. 13 explains the time slot allocation for the scenario shown where A is a parent of B, B is a parent of C and C is a parent to nodes D E and F. Once node B is informed by its parent on which time slot it could transmit and on which it has to switch to idle, it allocates the time slots to its child node C over the remaining time slot on the radio frame. In turn, once node C has been informed by parent node B on which time slots it can transmit and during which time slots it has to switch to idle, then node C is able to allocate time slots to its child nodes D E and F.

The time slot allocation shown in FIG. 13 makes sure that the transmissions of nodes D E F will not collide at C, whenever C is in transmit mode all child nodes will switch to idle. To keep this regime applicable, the maximum number of time slots that a parent can grant to a child per frame is limited to three. According to 3GPP standards, a load of 384 Kb/s can be mapped on three time slot units per frame of 128 Kb/s each.

Referring to FIG. 21, which shows a signalling strategy for resource allocation, the forms of inband signal messages carried over the assigned ATCH timeslot are:
Bandwidth Request Message (BW_Req_Msg) which is initiated by the child so the parent can schedule the child's transmission over the upcoming time frames whenever the child requests.
Tracking Message (Trk_Msg) used at the parent node for topology detection. This message is also used at the parent node for applying power control.

The parent node responds to the BW_Req_Msg by sending a Bandwidth Grant Message (BW_Grant_Msg) which contains the Transmission Schedule for the child node(s). The transmission schedule is sent in a signalling message over the ARACH.

The parent node also acknowledges to the child node that its signal has been received at an acceptable SIR level by sending an Acknowledgment Message (Ack_Msg) ARACH signalling message. If the signal is not received at an acceptable SIR, then a request to retransmit message (RReq_Msg) is initiated.

In the case that a parent node has more than one child, the parent node sets up the Ad hoc Local Beacon Channel (ALBCH). The ALBCH is located on TS#15 over the radio frame. During the probing procedure, the parent node would know whenever it can set up the ALBCH and instruct its children to hear information on this channel. This information would include:
The Transmission Schedule broadcast to all child nodes.
Tracking message used for topology detection and SIR adjustment as part of power control.
Signalling messages to release the Bandwidth assigned to “unwanted” child node according to probing updates.

The Transmission Schedule contains the subframe numbers and the number of TSs on which the child node is allowed to transmit, receive or switch to idle.

In the case where there is more than one child node, the Transmission Schedule will contain the TS number over which each child node will transmit over the allocated subframe.

In the case where an AUE desires to initiate its own data packets while it has a relayed message in its buffer, then it gives priority to the relay function before forwarding its own message.

The resource allocation strategy is shown in FIG. 14 and is described hereafter.

In step S14-1 the BW_Req_Msg is received from a child node and in step S14-2 it is then determined whether this child node is the only one in the Neighbours List. In the case there is only one child node, then in step S14-3, the parent is free to assign all ATCH timeslots in the available subframe to that child.

However, if at step S14-2 it is determined that this parent has more than one child, then in step S14-4 it is determined if more than one of the child nodes (up to a maximum of 3 children per parent) have applied for bandwidth (i.e. wish to transmit). If more than one child node has applied for bandwidth, then in step S14-5 the vacant ATCH timeslots in the subframe are assigned amongst the various children to define the specific time periods within which each child may transmit. On the other hand, if only the one child node is found in step S14-4 to have applied for bandwidth, then the other children will be instructed in step S14-6 to switch to idle and then in step S14-7, the single child desiring bandwidth will be allocated all of the timeslots of the ATCH subframe in which to make its transmission.#

Following steps S14-3, S14-5 or S14-7 the resource allocation procedure exits and reports back to the probing function.

In accordance with the above procedures, if there exist more than one child nodes, then the Transmission Schedule is set to contain the TS number over which each child node will be transmit on over the allocated subframe.

In the case that the AUE desires to initiate its own data packets while it has a relayed message in its buffer, then it gives priority to performing relaying first for the buffered data before it can start forwarding its own message.

Power Control

Power control will now be discussed.

In ad hoc mode, every AUE (ad hoc User Equipment) acts like a mini cell, using cell resources in the coverage area of the base station BS 10. For better re-use of the resources in ANOUP, the transmit power for transmitting AUE's (for instance 40A of FIG. 1) has to be controlled so that it does not fall below a level that affects the target quality of the link, nor increases more than necessary (which would degrade the quality of other links due to interference). In the SIR based power control employed herein, information about the path loss is available at the receive end (40B) and this information is fed back to the transmitter (40A) so that the transmitting AUE can make the decision on whether it has to increase or whether it may decrease the transmit power level.

In ANOUP, Probing, Signalling, and Forwarding Functions are all power-controlled.

In the power control method, the transmitter adjusts its transmit power level according to feed back commands from the receiver based on the Signal to Interference Ratio (SIR) level of the received signal.

SIR estimation is a very important aspect in ANOUP and is used to execute more than one function of the protocol.

SIR estimation in ANOUP is advantageous for its simplicity. It differs from conventional SIR estimation in digital communication which is based on calculating the bit error rate (BER) in the received data and then working out the equivalent SIR level at every BER value.

In ANOUP, however, since the relayed data messages are not de-coded and therefore the BER is not calculated, the SIR is calculated by means of correlating the received data on a chip level with a pre-determined midamble (MA) code that is sent with all transmitted packets. The output of the correlation will have a maximum; this maximum varies in proportion with the SIR level of the received signal.

Practically SIR estimation is achieved in two stages:
First stage the received packets (on chip level) are correlated using the common MA code transmitted with the radio packet.
Second stage the SIR is estimated by matching the maximum magnitude of the correlation at the output of the matched filter with the corresponding SIR value. In order to achieve this each AUE has to have an empirically obtained table for SIR verses correlation function maximum amplitude.

FIG. 15(a) shows the output of correlation and FIG. 15(b) shows an empirically obtained SIR versus correlation function maximum amplitude table (this table is obtained using Matlab communications toolbox.

FIG. 16 shows the Block diagram of the Power Control function. In the figure there is shown a Receiver 16-1, a Correlator 16-2, a Maximum Finder 16-3, and a Look-Up Table 16-4. The following table explains the functions of the various blocks:

| | |
|---|---|
| Receiver 16-1 | Receives the Data message on chip |
| | level i.e. no need to apply channel |
| | code only de-modulation and de- |
| | spreading is required. |
| Correlation 16-2 | Correlates the received signal with |
| | the Midamble code |
| Maximum Finder | Finds the maximum of the matched |
| 16-3 | filter output. |
| Look up table 16- | Matches the maximum amplitude of the |
| 4 | correlation function with its |
| | corresponding SIR value using a saved |
| | empirically obtained table. |

In ANOUP, the SIR based power control is initially achieved during the probing procedure while the AUEs exchange probing messages, this can be summarized in the following manner:
1. The AUE node sends the probing message (PMsg) to an AUE which will then be its parent (BN).
2. The parent node receives the PMsg and works out the SIR level of the received PMsg.
3. The parent node sends a power control command to its child with the probing reply (PRsp).

Further power control is achieved during the relaying phase in the way that the parent node estimates the SIR of its child node via relayed packets and feeds back the power control command within the acknowledgement message, this can be summarised in the following manner:
1. The parent node receives the relayed packet from its child node.
2. The parent node estimates the SIR level of the received relayed packet.
3. The parent node sends a power control command to its child with the acknowledgement message.

Signalling

Signalling messages are carried on the ARACH and on the ATCH. Signalling messages include power control messages, assurance messages, and messages to deal with link failure scenarios.

Signalling messages fall into two types: random access (RA) signalling messages carried on the ARACH channels and inband signalling messages carried on ARACH channel.

Signalling messages are power-controlled.

Some signalling messages have been discussed in various places in this disclosure and the other various ANOUP signalling messages are summarised in the following table:

| | | Originated | RA or |
|---|---|---|---|
| Message Name | Description | Function | inband |
| Bandwidth | Used by the | Resource | inband |
| Request Message | child node | Allocation | |
| (BW_Req_Msg) | applying for | | |
| | timeslot for | | |
| | its upcoming | | |
| | transmission | | |
| Bandwidth Grant | Reply to the | Resource | RA |
| Message | BW_Req_Msg | Allocation | |
| (BW_Grant_Msg) | with | | |
| | Transmission | | |
| | Schedule | | |
| Acknowledgement | Acknowledges | Resource | RA |
| Message | the | Allocation | |
| (Ack_Msg) | reception of | | |
| | the data | | |
| | packets of | | |
| | the child | | |
| Retransmission | Instructs | Resource | RA |
| Request Message | the child to | Allocation | |
| (RReq_Msg) | retransmit | | |
| | as its data | | |
| | packet is | | |
| | received | | |
| | poorly | | |
| Bandwidth | Sent by the | Resource | RA |
| Release Message | child node | Allocation | |
| (BW_Rel_Msg) | to the | | |
| | parent | | |
| | informing it | | |
| | that it has | | |
| | released the | | |
| | BW it | | |
| | occupies. | | |
| ALBCH setup | Sent by the | Resource | RA |
| message | parent node | Allocation | |
| (ALBCH_set_Msg) | to its | | |
| | children | | |
| | informing | | |
| | them to | | |
| | listen to | | |
| | the ALBCH | | |
| Tracking | Sent by the | Topology | inband |
| Messages | child node | Detection and | |
| (Trk_Msg) | and used for | Power Control | |
| | topology | | |
| | detection | | |
| | and power | | |
| | control. | | |

Forwarding

The forwarding function takes care of receiving the relayed data message and transmitting it to the parent node.

Forwarding functions include data buffering and slot building in addition to other functionalities related to the signalling functions

Over the assigned timeslot, the relayed data is mapped according to the 3G specifications. The AUE can map up to 16 data packet using 16 different channelisation (spreading) codes each of spreading factor of 16.

A block diagram of the forwarding function is shown in FIG. 17 of the drawings. In the figure, there are shown a Receiver module 17-1, a Transmission Control module 17-2, an SIR Estimation and Fine Synchronisation module 17-3, a Data Buffer 17-4, a Timeslot Builder 17-5 and a Transmitter 17-6 which co-operate with the Topology Detection TD, Signalling S and Resource Allocation RA modules. The functions of the various blocks are given in the following table:

| Receiver 17-1 | Receives the Data message on chip |
|---|---|
| | level i.e. no need to apply channel |
| | code, only de-modulation and de- |
| | spreading is required. |
| Transmission | Instructs the transmitter and the |
| Control 17-2 | receiver to switch on/off over the |
| | upcoming radio frames according to the |
| | Transmission Schedule which is updated |
| | every time frame from the Resource |
| | Allocation Function. |
| SIR Estimation | Estimates the SIR ratio of the |
| and fine | received signal, this estimation |
| synchronisation | is used for power control (more |
| 17-3 | information in power control |
| | function) |
| | Estimates the synchronisation |
| | rift. This information is fed |
| | back to the transmitter and used |
| | for peer to peer fine |
| | synchronisation. |
| Data Buffer 17-4 | Buffers (saves) the relayed data for |
| | the time being until it can be re- |
| | transmitted. The buffer is rest by the |
| | Signalling function whenever the child |
| | node receives Ack_Msg from its parent. |
| | Also it is reset by the Topology |
| | Detection Function whenever it detects |
| | a topology change. |
| Timeslot Builder | Maps the buffered data according to |
| 17-5 | the 3G specifications. |
| Transmitter 17-6 | Sets the transmission level |
| | according to power control |
| | function. |
| | Modulates and transmits the |
| | packet according to instructions |
| | from the Transmission Control. |

Topology detection

The Topology Detection Function is responsible for detecting whenever the neighbour nodes are relocated within the locality and for detecting whenever a node moves to a new locality.

The Topology Detection function is initiated after the Neighbour List has been filled with the minimum number of neighbours of each class.

The worst case scenarios for topology change are shown in FIG. 18 and can be summarised as follows:
1. Scenario 1: whenever the child node is lost.
2. Scenario 2: whenever the child node is relocated and is no longer in a position to be a child node.
3. Scenario 3: Whenever the AUE walks away from its locality.

As a topology change is detected, follow up measures take place to react to these changes.

Topology detection is achieved by working out the relative positioning of the surrounding neighbours using reference power measurement and tracking messages.

As the child node has the facility of inband signalling to its parent, the child node plays an important role in topology detection.

The child node is required to send Tracking Message (Trk_Msg) over the initially assigned ATCH timeslot. The Trk_Msg contains an update of the measurement of reference power and is also used by the parent in the power control function.

The parent node may also provide a Trk_Msg which is transmitted over the ALBCH in case it has more than one neighbour.

The ANOUP Topology Detection function mechanism is summarised in FIG. 19.

In the flow diagram of FIG. 19, the Topology Detection function performs a first step S19-1 of Measuring the AUE reference power Pref. Next, in step S19-2 it is checked whether the Pref value received is greater than the Pref received at its farthest away PDN or less than the Pref of its furthest PSN—if the answer to this is yes, then this is indicative of a change of locality scenario in which the AUE is no longer in its original position as it has moved out to a new locality and so in step S19-3, the Neighbour List is reset and Probing Activity is set to high. If in step S19-2, the answer to the Pref test is “No”, the AUE in s19-4 check whether the Trk_Msg are still emitted by its child. If the expected Trk_Msg is not heard, then this is indicative at step S19-5 of a lost child scenario—in which case, the bandwidth which had previously been assigned to that child is released and an addressed PMsg is sent to the closest next neighbour classified as a Potential Source Node (PSN) asking if that PSN wishes to become a new child. In step S19-6, it is checked to see whether the addressed PSN accepts the offer of child status. In step S19-7, if the PSN has accepted child status, then probing activities at the parent are set to low, whereas if the PSN does not accept child status, then probing activities are set high in step S19-8.

If on the other hand step S19-4 reveals that the Trk-Msg from the child was received, then in step S19-7, the Pref value calculated in step S19-1 is compared with the Pref value sent by the child. Next, in step S19-10 it is checked whether the Pref from the child is greater than the Pref of the AUE. If Child Pref is not greater than the parent AUE Pref, then this indicates that the child is still a viable child node and no action is taken at step S19-11. On the other hand, if Child Pref is greater than parent AUE Pref, then this means that the child has now moved to a position intermediate the parent and the BS 10 and has therefore relocated to a position where it is again no longer a viable child node—in which case at step S19-12 bandwidth assigned to that child is released and probing activity is set high.

Handset and Base Station Implementations

In each of the preceding sections, the various functionalities for implementing Ad hoc networking in a Universal Mobile Telecommunications System have been described.

The skilled man will appreciate that the ANOUP method described is specifically designed to be used within existing 3G networks, without any necessary change in existing standards—rather the ANOUP method will require adoption as an add-on feature, i.e. as an extra standard appended to existing standards.

The skilled man will also realise that at individual handsets on which the Ad Hoc features are enabled, software enabling the implementation of ANOUP is required, but no hardware changes need to be made, other than ensuring that the handsets have sufficient processing power and storage for the extra functionality. For example, items such as storing the Neighbour List and for implementing the various sub-routines making up the protocol (Probing, Signalling, Topology detection, Routing etc.) may need processor/memory upgrades. On the other hand, if appropriate, particular implementations may desirably provide dedicated hardware features for implementing specific parts of the ANOUP methods, so, for instance, an extra dedicated processor and dedicated storage facilities may be provided and linked to address and data buses of the regular processor/storage facilities.

FIG. 20 provides a simplified illustration of a mobile handset for implementing ANOUP, comprising antenna 20-1, ANOUP switch 20-2, receiver and filtering module 20-3, transmitter and amplifier 20-4, an UTRA functions processor 20-5 and an ANOUP functions processor 20-6.

In the figure, the antenna 20-1 is selectively connectable to either the receiver and filtering module 20-3, or the transmitter and amplifier 20-4 according to the transmit/receive state. The processor 20-5 controls all normal signalling and computational functions in UTRA mode, receives input from the receiver and filtering module 20-3 and provides prepared messages and signalling to the transmitter amplifier 20-4. Control software for controlling operations of the processor 20-5 and data, messages, address book details etc. requiring to be stored is all kept in appropriate storage (not shown). When operating in Ad hoc mode however, ANOUP functions processor 20-6 takes over control of transmit/receive functionality and will receive input from the receiver and filtering module 20-3 and provides prepared messages and signalling to the transmitter amplifier 20-4. Again, control software for controlling operations of the ANOUP functions processor 20-6 and data, messages, address book details etc. requiring to be stored is all kept in appropriate storage (not shown).

The switch 20-2 operates so as to selectively connect either the UTRA functions processor 20-5 or the ANOUP functions processor to the transmitter/receiver modules 20-4, 20-3 and is itself controlled by the decision on whether to go into Adhoc mode or not. This decision is reached on the basis of beacon channel measurement—if the received power of the beacon channel is greater than a threshold value, then operation is according to UTRA conventional methods, whilst if the received power of the beacon channel is less than the threshold value, then ANOUP operation is adopted. Here, the threshold value may be set as being the minimum power level received by the user equipment from the base station that implies that a message transmitted from the user equipment to the base station is likely to be just (reliably) receivable.

In connection with the above discussion, it will be appreciated therefore that whilst the arrangement shown in FIG. 20 shows a dedicated processor for ANOUP functions and a physical switch for changing functions between ANOUP and UTRA, this schematic block diagram may find implementation in software (rather than hardware). In such a case, the usual physical construction of a User Equipment (mobile handset) can be retained and a single processor used for implementing both conventional UTRA and ANOUP functions, provided that the Processor and Storage modules are sufficient, or these modules may be upgraded to cope with the extra functionality.

As far as the Base Station BSl0 is concerned, no specific extra hardware over and above the hardware necessary for UMTS is needed to make use of ANOUP. The following points are of relevance to note however.

If ANOUP is used for the purpose of extending cell coverage, then the BS will need to increase the coverage of the beacon channel proportionately to the desired coverage extension desired.

If ANOUP is required to support high data rates in the uplink direction in a dense network for a user located at the boundary of the cell, then no specific change in the beacon channel is needed—however, the received power threshold upon which the user equipment makes the decision on whether or not to operate in ad hoc mode may change.

If the base station is UTRA-FDD based, then no change in radio resource allocation strategy is required for prevention of mutual interference—uplink transmissions over the original cell coverage area are executed on the FDD spectrum, while transmissions over the extended cell coverage area are executed on the TDD spectrum meaning that there is expected to be no mutual interference between one hop transmissions in the original area and adhoc transmissions in the extended area.

If the base station is UTRA-TDD based then the resource allocation strategy at the BS is such that one hop transmissions within the original coverage area are executed on different timeslots to those allocated for Ad hoc transmissions in the extended area. This is not a problem as timeslot allocation in UTRA-TDD for uplink and downlink is asymmetric and is flexibly managed by the network operator. There is also the possibility to separate transmissions and hence reduce mutual interference over the two coverage areas by scrambling (i.e. increasing the separation on the code domain where the spread data over the extended coverage area is scrambled using different codes to the scrambling codes used in the original coverage area).

As far as capacity goes, normal uplink direction transmissions are not limited by use of ANOUP. However, in the specific case where ANOUP is used to support an increase in data rate at the cell's boundary within a dense cell, then BS capacity can be affected and strategies for increasing BS capacity might need to be looked for. In non-dense cells BS capacity in Uplink/Downlink directions is not a problem.

Ultimately downlink capacity from any base station does have limits and, when coverage is extended and demand increases, then such limits could conceivably be approached. If this limit is seen to be a problem, then fixed downlink repeaters at the cell boundary may be a good solution.

From the above description it will be seen that short range ad-hoc networking in a cellular environment enables remote ends to communicate and has a large number of advantages:
1. Despite limitations on the transmitting power of the user's handset, short-range ad-hoc communications provide connectivity between source and destination.
2. Radio resources may be localised to cover only a small transmission area and those which are no longer needed can be redeployed elsewhere.
3. The interference generated as compared to single hop (handset direct to base station) communications is reduced.
4. The system proposed is backward compatible, so that existing (non ANOUP enabled) handsets may continue to operate as before in the network.
5. Where a handset has enough processing power and storage, an existing handset may be provided with a software upgrade to enable ANOUP features.
6. In a network running ANOUP, fewer base stations are required to cover a given area.

Whilst various procedures, protocols and frame structures for implementing the invention have been discussed, the skilled man will realise that the invention is not limited to the specific examples described, but only by the claims. Further, wherever software arrangements are envisaged, these may be replaced by hardware equivalents and vice versa without departing from the scope of the invention.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method for ad hoc networking over a universal mobile telecommunications system (UMTS), wherein, in an uplink procedure at a User Equipment end in which a message is to be transmitted from the User Equipment to a Base Station, the User Equipment is arranged to not transmit its message directly to the Base Station, but instead to forward it towards the Base Station via one or more intermediate User Equipments by means of
(a) synchronizing itself with the Base Station to acquire timeslot and frame synchronisations that will enable the User Equipment to listen to a broadcast channel and measure the reference transmit power of that channel;
(b) performing probing activities to build up a list of neighboring User Equipments and work out the relative positions of its neighbors with respect to the Base Station and itself
(c) on the basis of the relative positioning information come to a routing decision for forwarding its message towards the Base Station;
(d) performing a resource allocation function in which transmission resources are allocated to support transmission of the message; and
(e) forwarding the message.

2. The method of claim 1, wherein synchronisation between User Equipments and a Base Station is acquired in two ways:
(a) Listening to a beacon channel transmitted by the Base Station which carries synchronisation information; and
(b) if the beacon channel cannot be heard by a particular User Equipment, then synchronizing the particular User Equipment by means of peer-to-peer synchronisation.

3. The method of claim 2, wherein where a particular User Equipment is outside of the range of the beacon channel the asynchronous receiver is arranged to listen for a packet transmission from a transmitting synchronized User Equipment.

4. The method of claim 3, wherein each packet transmitted by a synchronized User Equipment includes a known portion having a predetermined content which is guaranteed to be present at a particular place within a transmitted packet and the asynchronous User equipment listens for the predetermined content to thereby synchronize itself with the synchronized User Equipment.

5. The method of claim 4, wherein the asynchronous User Equipment performs a correlation calculation to determine when the predetermined content is transmitted by the synchronized User Equipment.

6. The method of claim 5, wherein as soon as an as yet asynchronous User Equipment switches on, the asynchronous User Equipment starts to correlate the bursts it receives with a predetermined midamble code for the length of a transmission time slot.

7-8. (canceled)

9. The method of claim 1, wherein probing comprises the user equipment transmitting a signal to neighboring user equipments and building a Neighbor List listing and classifying said neighboring user equipments according to their positions relative to the User Equipment and the Base Station.

10. The method of claim 9, wherein the probing function comprises the procedure of the user equipment sending a probing message signal to its neighbors and requesting their reply in order to build up the Neighbor List.

11-48. (canceled)

49. A User Equipment adapted to operate within an Ad hoc networking environment, wherein the User Equipment comprises a transmitter for transmitting signals to a base station, a receiver for receiving signals from a base station, memory for storing incoming messages, control software and other data, and a processing unit for controlling functions of the User Equipment, the User Equipment being characterized in that the receiver is further arranged, in an Ad hoc operating mode, to
(a) synchronize itself with the Base Station to acquire timeslot and frame synchronisations that will enable the User Equipment to listen to a broadcast channel and measure the reference transmit power of that channel;
(b) perform probing activities to build up a list of neighboring User Equipments and work out the relative positions of its neighbors with respect to the Base Station and itself
(c) on the basis of the relative positioning information come to a routing decision for forwarding its message towards the Base Station;
(d) perform a resource allocation function in which transmission resources are allocated to support transmission of the message; and
(e) forward the message.

50. (canceled)

51. A User Equipment according to claim 49, wherein the memory includes a Neighbors List area for storing the details of neighboring User Equipments.

52. (canceled)

53. The User Equipment of claim 49, wherein the User Equipment comprises a dedicated processor for controlling functions of Ad Hoc networking.

54. The User Equipment of claim 49, the User Equipment is provided with synchronisation means to enable the User Equipment to synchronize itself with the Base Station to acquire the timeslot and frame synchronisations that will enable it to listen to a broadcast channel and measure the reference transmit power of that channel.

55. The User Equipment of claim 54, wherein synchronisation between the User Equipment and a Base Station is acquired in two ways:
(a) Listening to a beacon channel transmitted by the Base Station which carries synchronisation information; and
(b) if the beacon channel cannot be heard, then synchronizing the particular User Equipment by means of peer-to-peer synchronisation.

56. The User Equipment of claim 55, wherein where a particular User Equipment is outside of the range of the beacon channel the asynchronous receiver is arranged to listen for a packet transmission from a transmitting synchronized User Equipment.

57. The User Equipment of claim 56, wherein each packet transmitted by a synchronized User Equipment includes a known portion having a predetermined content which is guaranteed to be present at a particular place within a transmitted packet and the asynchronous User Equipment listens for the predetermined content to thereby synchronize itself with the synchronized User Equipment.

58. The User Equipment of claim 57, wherein the asynchronous User Equipment performs a correlation calculation to determine when the predetermined content is transmitted by the synchronized User Equipment.

59. The User Equipment of claim 58, wherein as soon as an as yet asynchronous User Equipment switches on, the asynchronous User Equipment starts to correlate the bursts it receives with a predetermined midamble code for the length of a transmission time slot.

60-61. (canceled)

62. The User Equipment of claim 49, wherein probing comprises the user equipment transmitting a signal to neighboring user equipments and building a Neighbor List listing and classifying said neighboring user equipments according to their positions relative to the User Equipment and the Base Station.

63. The User Equipment of claim 62, wherein the probing function comprises the procedure of the user equipment sending a probing message signal to its neighbors and requesting their reply in order to build up the Neighbor List.

64-118. (canceled)
